(19) United States
(12) Patent Application Publication
(10) Pub. No.: US 2002/0057441 A1
(43) Pub. Date: May 16, 2002

(54) IMAGE CACHING IN AN OPEN PREPRESS INTERFACE

(76) Inventors: JINDONG CHEN, BELMONT, CA (US); ERIC J. THIBODEAU, WESTMINISTER, CA (US); GENE A. MCDANIEL, LOS ALTOS HILLS, CA (US)

Correspondence Address: RONALD ZIBELLI, XEROX CORPORATION, XEROX SQUARE 20A, ROCHESTER, NY, 14644

(21) Appl. No.: 09/006,518

(22) Filed: Jan. 13, 1998

(51) Int. Cl. G06F 15/00

(52) U.S. Cl. 358/1.2

(57) ABSTRACT

An improved method of Open Prepress Interface (OPI) processing of a page containing text and a picture. A low resolution Postscript Master is made from the text and a low resolution version of the picture, the result being sent to the OPI consumer. Here, processes that can be accomplished with the low resolution picture, such as location and cropping, are accomplished. Next, the low resolution picture is replaced with the high resolution version, and high resolution image processes are done, such as rotation and scaling for the intended printer. The result is stored. Finally, a printer's Postscript interpreter is used to generate a raster and the picture is printed. The advantage is that if a change needs to be made to the page after printing, the high resolution picture from storage can be used so that the high resolution image processing need not be repeated

### BACKGROUND OF THE INVENTION

A method of using an Open Prepress Interface (OPI) for image processing (scaling, rotating, etc.) the high resolution image as well as placing this image into the document, so that the final electronic image can be stored more easily by the user.

The Open Prepress Interface, sometimes referred to as an image replacement strategy, was created for the users (graphic artists) who perform the page layout which includes the manipulating and locationing of high resolution pictures in digitized form. Since high resolution images are so large, the manipulations can take a very long time. For this reason, OPI allows the use of a low resolution image during page layout, but have the high resolution image appear on the printed page. The graphic artist could have created the high resolution image from a scanner or it may have come from a CD or electronic catalog.

A typical image replacement process is: Both high and low resolution versions of an image are created and stored into an image database. The user retrieves low-resolution versions of the images and creates a document with a page layout program. Using the page layout program, the low resolution versions can be rotated, scaled, and cropped. These image transformations are quick because they are done on the low resolution version. When a hardcopy print is needed, the page layout program generates a Post Script (PS) Master. At this point the page layout program is in a position to automatically insert OPI commands into the PS Master. These commands include cropping, resizing and rotating the low resolution image. The PS master from the user is sent to the OPI Consumer which is a layer of software which usually resides with the final printing service. Here, the system replaces the low-resolution images with the high-resolution versions. Finally, the layout is sent to a Postscript interpreter, which can crop, scale or rotate the images and puts the page into a form that can be used by the particular printing press or printer to print the final pages. The Postscript interpreter is associated with a particular printer, and in the case of high-end printers, is built into the front end. This entire process is detailed by the OPI specification which describes the processes to be performed by the OPI Consumer and Postscript Interpreter.

The software can be seen as being divided into two layers, the OPI Consumer, and the PS Interpreter. The first layer, the OPI Consumer, does the general operations that can conveniently be done without being limited to a specific printer, basically the image replacement. Thus, the output of the OPI Consumer is in a form that can be sent to any printer. The second layer of software is executed after a particular printer is identified. Here the data is put into a format, including a printing pixel density, that is required by the target printer. In a network, this leads to the arrangement where there may be a number of printers, each with its interpreter being supplied by one central OPI consumer.

The advantages of image replacement are savings in time and file storage since the page layout process is not encumbered by moving around high resolution color image files. Another benefit is a division of labor that makes sense for many publications. Existing OPI strategies support the most commonly used page layout programs. For example, Compumation's Color Central OPI system works with QuarkXPress, Adobe PageMaker, Multi-Ad Creator and FrameMaker.

However, the process is still time consuming, especially because the image manipulations (rotation, scaling, etc.) of high-resolution images, up to 100 Megabytes each, are so computationally intensive. This is especially true when several final proofs are generated, allowing the user to make small final corrections. Each time, the high resolution image processing needs to be repeated. There is a need in the industry for a faster process. Also, in this system there is no place at which a final version of the image can be stored for future use. The PS master contains the unrotated, unscalled, high resolution image as only a set of bits in a PS Master which the interpreter manipulates and converts, line by line, into a series of bits to be sent to the printer. The interpreter has no knowledge of the source of these bits, and therefore can not do any intelligent processing or time savings based upon prior results.

### SUMMARY OF THE INVENTION

This invention improves the process by enabling the OPI Consumer to manipulate the high resolution image, so that the final image is available to the user for reuse on subsequent prints. This saves time where small changes are made to the final proof that do not involve the image. In this case, the high resolution image is simply copied from storage, so the final rotation and scaling by the Postscript Interpreter does not have to be repeated for each proof. Because of the large number of pixels in each high resolution image, the OPI consumer must have access to a large disk library. The space needed would be increased to accommodate additional variations of images that have been cropped, scaled, or rotated. To efficiently manage the space a caching algorithm is implemented. Finally, the version thus produced by the OPI consumer is no longer in a form that can be sent to any printer (but could go to a class of printers); it is now scaled and may also be color space transformed for a single printer class. However, it has been determined that these added requirements and limitations are more than offset by the increased speed of processing.

Of course, if the user knows that he wants the same image, with the same manipulations, he used for this final page on the previous iteration of proof reading, or the same image he used several weeks before in a different document, he can create it and then specify it. However, this process can also be automatic and transparent to the user. The OPI Consumer can examine the current image name and processing, compare it to all of the stored images, and use a similar previous image if it is identical in all respects or easily derived from other saved images. Thus, the system will access the previous image even if the user doesn't know, or forgot, that it exists; and will save the user's time in any case by automatically accessing it.

It should be noted that even if the user of the prior art system did decide to store the final high resolution image, it can not be done in the prior art system since at the second PS Master stage the image is still missing the position, size, rotation and skewing of the final image, and after the Postscript Interpreter, the data has been reduced to a stream of binary bits which is unintelligible to the user, and which is useful only to feed the particular printer being used.

### BRIEF DESCRIPTION OF THE DRAWINGS

FIG. 1 is a flow chart of the standard, prior art OPI processing.

FIG. 2 is the improved OPI processing with image processing and caching.

### DETAILED DESCRIPTION OF THE INVENTION

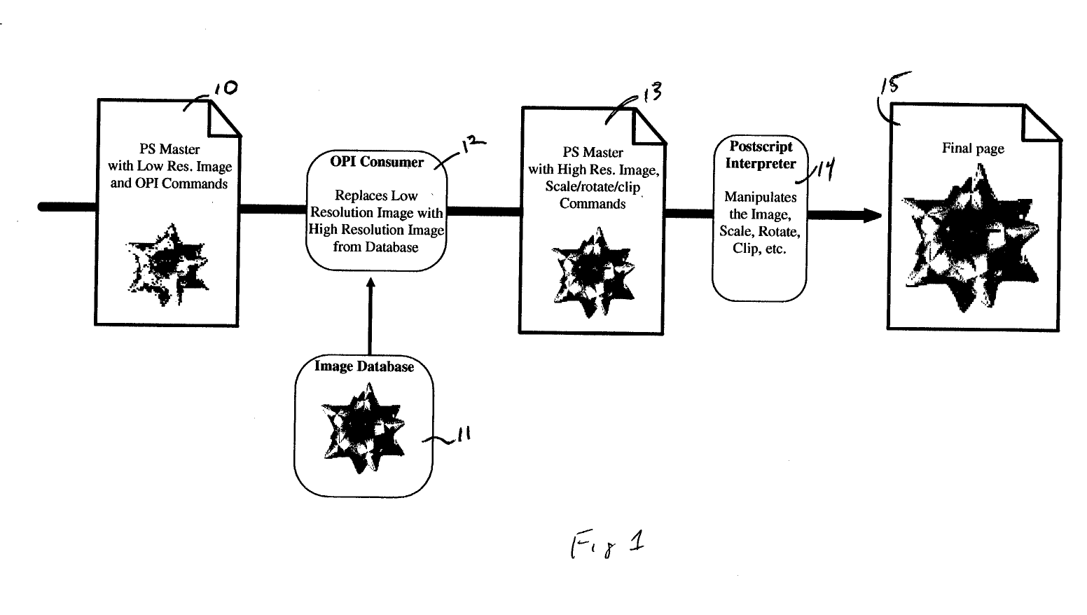

FIG. 1 is a flow chart of the standard, prior art OPI processing. The user, typically working at a computer, and using a standard software page layout package like Quark Xpress or Adobe Pagemaker, generates a PS Master 10 which consists of text, low resolution images received from the prepress house and OPI commands about how the various items shall be located, rotated, scaled, etc.

Next, the OPI Consumer 12 (Such as Color Central) combines the high resolution image from an Image Database 11, with the PS Master 10 to form a second version of the PS Master 13. This is sent to the PS Interpreter 14 (Such as an Adobe PS Interpreter, or Xionics PS Interpreter) which puts the entire package into a form that the printer can use to generate the hard copy, or final page 15.

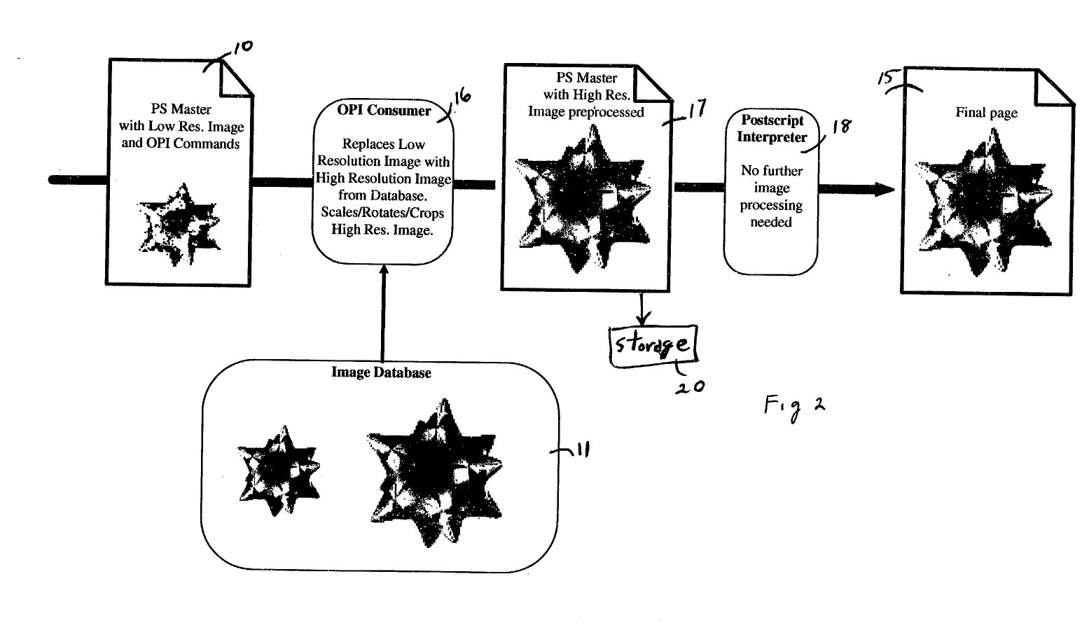

FIG. 2 is the improved OPI processing with image processing and caching. As before, the user generates the first PS Master 10 in Quark Xpress or Adobe Pagemaker. This is processed in the OPI Consumer 12, where image processing (rotation, scaling, etc.) takes place (Box 16) to produce a manipulated image 17. The Manipulated image 17 goes back into the image database 11 as a cached image. The OPI Consumer produces the second PS Master 13. Finally, the second PS Master 13 is converted into a printerusable version by the PS interpreter 14 to produce the final page 15 on the printer. Using this system, for subsequent prints, steps 16 and 17 may be skipped by using the image cached in the database.

While the invention has been described with reference to a specific embodiment, it will be understood by those skilled in the art that various changes may be made and equivalents may be substituted for elements thereof without departing from the true spirit and scope of the invention. In addition, many modifications may be made without departing from the essential teachings of the invention.

What is claimed is:

1. Apparatus for combining text and high and low resolution versions of a picture to form a printed page comprising:
user means for combining the low resolution version and the text to form a low resolution master,
an Open Prepress Interface Consumer (OPI) for
a) combining the low resolution version and text onto a first master,
b) locating or cropping the low resolution version, if necessary,
an image processor for replacing the low resolution version with the high resolution version and for rotating or scaling if necessary to form a high resolution master,
a memory to store the high resolution master,
a Postscript Interpreter to convert the high resolution master into a raster, and
a printer to print the raster.
